(19) United States
(12) Patent Application Publication
(10) Pub. No.: US 2015/0134325 A1
(43) Pub. Date: May 14, 2015

(54) Deep Language Attribute Analysis

(71) Applicant: Avaya Inc., Basking Ridge, NJ (US)

(72) Inventors: David Skiba, Golden, CO (US); George Erhart, Loveland, CO (US); Lee Becker, Boulder, CO (US); Valentine C Matula, Granville, OH (US)

(73) Assignee: Avaya Inc., Basking Ridge, NJ (US)

(21) Appl. No.: 14/080,618

(22) Filed: Nov. 14, 2013

(51) Int. Cl. G06F 17/27

(52) U.S. Cl. CPC G06F 17/2785
USPC 704/9

(57) ABSTRACT

Contact centers may benefit from routing messages to agents who have similar, or complementary, attributes as the customer of the message. In a text message, certain message attributes provide artifacts that may be common to one particular customer attribute. Messages containing that particular message attribute provide a derived customer attribute and the message routed accordingly. In addition, agents responding to a customer may be provided with guidance to ensure their response is appropriate for the derived customer attribute of the customer.

### FIELD OF THE DISCLOSURE

The present disclosure is generally directed toward routing contacts in a contact center. More particularly, routing contacts to a contact center based on detected attributes of the contact.

### BACKGROUND

Contact centers often try to match the contact (e.g., the person calling, emailing, texting, etc.) with a human and/or automated agent that can understand the contacts needs and resolve the matter in question as efficiently as possible.

One aspect of human conversation is a preferred language. As a result, many contact centers ask customers to select a language. This query is usually performed via an interactive voice response (IVR) or speech recognition program that prompts customers to, “Press 1 for English,” and, as recited in the respective native language, to press other keys for other languages. However, language alone provides a narrow picture of the customer's needs or preferences from a conversational perspective.

### SUMMARY

It is with respect to the above issues and other problems that the embodiments presented herein were contemplated.

Certain embodiments disclosed herein use a set of derived attributes to influence routing and evaluate responses from agents to ensure a match to the communication/conversational needs or preferences of the customer. Channels used to facilitate communications between a customer and contact center may include email, video/audio/text chat, SMS, social media, or combinations thereof.

In some embodiments, a contact center is disclosed with the ability to detect the existence of conversational attributes through various derived models of text and language. Pre-determined appropriate routing parameters and considerations would be enforced based on the attributes. During a conversation, an agent-customer communication would be validated and kept in the appropriate mode/attribute set to ensure efficient communication. After the communication is completed, the attribute set could further be automatically updated and/or stored in a Customer Relationship Management (CRM) database.

The set of derived attributes may be discovered through language understanding and text processing models trained to find these specific differences. The attributes may include:
Formal vs. informal text: In many languages, there is the concept of formal communication. Formal communication is often used in business or with a new acquaintance/people one doesn't know. The concept of informal communication may be used with family or in a more casual setting. It may be advantageous to route to an agent who is better at one mode over the other and to make sure the agent response matches the customer's mode preference.
Conversation Grade Level/Education level: The level of education and/or vocabulary may influence the choice of words or language constructs. This information could be used to route a customer to an agent capable of interacting at a detected or similar level. This information might also be used to verify that responses are of the appropriate level and are not considered “over the head” of the customer or under the customer level of understanding.
Gender: Gender differences may be discovered in language analysis. Some languages have a different format when interacting with a male person that is different from interacting with a female person. This gender format detection could be used to further proof-check outbound messages.
Native vs. non-native speakers: A non-native/non-fluent speaker tends to drop words and have a lower vocabulary level for his or her non-native language. This lack of language vocabulary and aptitude might be used to route to an appropriate agent or to an agent that speaks his or her native language, if detected. This information could be used to verify the outgoing language matches or closely matches the attributes of the incoming language. The examples might be to identify speech that has elements of more than one language, such as “Chinglish” or “Spanglish.” In this case, the customer might be trying to use English even though it is not his or her native language. The system may prompt the speaker to switch to their native language if an agent is available or route to an agent that is adept at using a degraded/mixed form of English. This information may also be used to draw upon a pre-formed set of answers or responses that have been created specifically to be very simple or very clear (e.g., having removed the use of language-specific or region-specific idioms, for example).
Domain expert vs. domain novice: This information would be used to ensure the conversation level is at the appropriate technical level for the customer. This would be useful and common in technical fields/technical support environments to avoid talking over or under a customer's skill level.

The following non-limiting example may further help the understanding of how a deep language analysis can enhance contact center operations:

Expert Customer: “Just downloaded Windows 8 and I cannot receive Xfinity email on Outlook. I suspect that Windows 8 does not support POP3. Can I use IMAP or other services? How can I connect Outlook and Xfinity email?”

Embodiments of the present disclosure enable an automated system to analyze the customer's comments/questions and identify the customer as a technical expert. Specifically, the customer uses terms like POP3 and IMAP which indicate an understanding of e-mail protocols that should label this as a technically savvy customer. It is likely that this customer should be routed to a higher level tier of support where the expectation is that the user is capable of talking in more technical terms.

Novice Customer: “Can't open e-mail. I tried different browsers as well. That is what they tell me to do first. This is getting old.”

In this communication, the customer fails to demonstrate any understanding of how e-mail works. The system proposed herein may automatically determine that the customer needs to talk to a lower skilled (and lower cost) support agent that would walk them through a pre-defined diagnostic procedure.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine,” “calculate,” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that other aspects of the disclosure can be separately claimed.

### BRIEF DESCRIPTION OF THE DRAWINGS

The present disclosure is described in conjunction with the appended figures:

FIG. 1 is a message processing diagram in accordance with embodiments of the present disclosure;

FIG. 2 is a contact routing diagram in accordance with embodiments of the present disclosure;

FIGS. 3A-3B illustrate a message processing diagram in accordance with embodiments of the present disclosure;

FIG. 4 illustrates a flowchart to create a record of the attribute database in accordance with embodiments of the present disclosure; and

FIG. 5 illustrates a flowchart to process a received message in accordance with embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

It should be noted that the embodiments herein are described with respect to the English language (except where noted) as a matter of convenience only. The use of non-English languages in the embodiments provided herein are also contemplated. Moreover, mixed languages may also be supported without departing from the scope of the present disclosure. Embodiments utilizing a particular non-English word or words are provided to illustrate a second language. It should be further noted that, absent a specific instruction to the contrary, references to elements of the figures that include a subelement designation (e.g., “102A”), but are used herein without the subelement designation (e.g. “102”) refer any one element having a like element number, when such usage is singular, or any plurality of elements with a like element number, when such usage is plural.

Contacts generally represent an individual in contact with a contact center to: make a purchase, provide information, get answers to questions, and the like. Contacts may utilize any form of communication including, but not limited to, text, email, telephony voice, audio chat, video chat, text chat, social media message exchanges, combinations thereof, and so on. The embodiments herein are generally directed towards written messages; however, many of the embodiments herein may be implemented with manual and/or machine-based transcriptions of messages with audio content.

Customers, in certain embodiments described herein, create and send messages. These messages usually become a contact in a contact center and are generally described as having customer attributes (e.g., attributes representing some aspect of the customer that is associated with the messages/contact). Additional embodiments may include immediate routing, such as when a particular customer attribute is detected in a message, which has not yet been processed, as well as future routings. For example, a particular message exchange with an agent exchange may reveal a particular customer attribute. However, rerouting the contact to another agent may not be an option or may not be a desired business practice. As a result, future messages from the customer may be routed according to embodiments described herein.

Contacts may provide indicators about themselves to allow the contact center to route the contact to an agent with a particular attribute or skill set to service such contacts. As one example, a florist may determine that male callers are more likely to upgrade flower purchases when ordering from a female agent and route the contact to a female agent. In another example, a contact fluent in English may insert a, “ja” (German for yes) into an English-based conversation. The contact center may determine that it is more effective, efficient, or otherwise desirable to route the contact to an agent with a particular fluency in German as well as, or instead of, English and route the contact accordingly.

Similarly, determining the comfort with formal/informal forms of conversation, education/conversation level, and domain expertise, in addition to, gender and native/non-native language skills may provide contact centers with information than may useful in routing a contact to an agent who can better service the contact.

In another embodiment, machine learning is provided. The specific word or words used to determine the customer attributes may be determined based on an analysis of past communications from a pool of prior messages and/or customers. In further embodiments, the degree of correlation of a particular customer attribute to an indicator may be determined. For example, the analysis of a large number of emails from known contacts may determine that a particular word is associated with males 48% of the time and females 52% of the time. As a result, future contact using that particular word may be slightly weighted as a female. Other words with a higher distinction, say 87% male/13% female, may cause the gender indicator be highly weighted towards male and routed accordingly. The specific cut-off point of what is, or is not, a strong enough indicator to justify a routing decision being made on such a factor, is a matter of implementation choice. For example, a weak indication of particular gender may be important to a contact center providing one kind of service or product information, whereas another contact center requires a very strong indication of a particular gender before making a gender-based routing decision, and still another contact center may be indifferent to gender and instead base routing decisions on other attributes. In the foregoing example, the different contact centers may be the same contact center providing various services and/or product information. Additional embodiments are provided with respect to the figures.

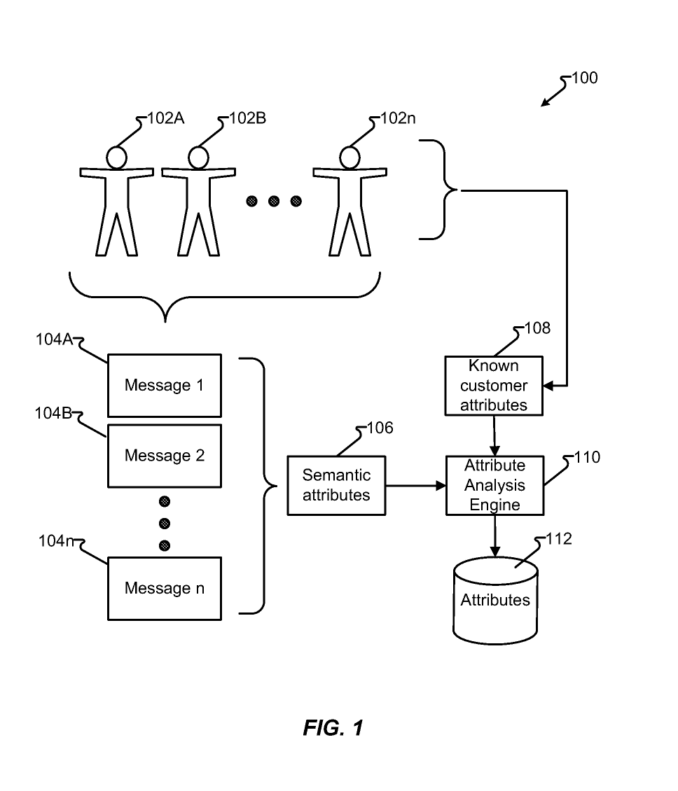

With reference now to FIG. 1, a message processing diagram 100 will be described in accordance with embodiments of the present disclosure. In one embodiment, customers 102 generate and/or send messages 104. Messages 104 may be one or more of text, emails, social media/message board comments and/or message threads, text chats, and/or transcriptions of voice conversations from telephone conversations or messages, audio chats, and/or audio portion of video chat.

In another embodiment, messages 104 and their elements are processed to derive a number of semantic attributes 106 describing the message 104 and/or a conversational ability of the customer 102 that generated the message 104. The message elements may be specific words or phrases, spelling of words, word order, idioms, punctuations, capitalizations, mistakes, references (e.g., time, day, place, product, likes, dislikes, employment, activities, etc.), tenses, or other message based content. In a further embodiment, certain metadata of a message 104 may also be a message element. Examples of such metadata may include, without limitation, identification of the customer via internet provider, IP address, device type (computer, tablet, smart phone, kiosk, etc.), operating system, time of day, day of week, day of year, name, username, domain name, and so on.

In some embodiments, customer attributes 108 may be obtained directly from the customers 102 instead of being obtained from an analysis of the messages 104. The known customer attributes 108 and semantic attributes 106 are analyzed in attribute analysis engine 110 and stored in attributes database 112. Attribute analysis engine 110 may be configured to determine an association between known customer attributes 108 and semantic attributes 106. Although the specific determinations possible are nearly endless, in one example, if attribute analysis engine 110 determines that one of the semantic attributes 106 is the use of certain texting shorthand terms (e.g., “lol”—laughing out loud, “jk”—just kidding, “brb”—be right back, etc.) are found in messages from customers 102, with a known customer attribute 108 indicating an age between 12 and 35, then attribute database 112 may be populated with a record indicating that such shorthand terms are associated with the customer attribute indicating an age, a likely age, a likely match to an age category, and so on. As will be discussed more fully below, a contact center which receives a new message which includes the message element, “lol” may then be indexed in attribute database 112 and determined to be indicative of a customer who is younger than 35 and routed to an agent accordingly.

As illustrated above, the order of operations may be to determine a semantic attribute 106 and then match the known customer attribute 108 to that particular semantic attribute 106. In such an embodiment, what is written is known and who writes it is then determined. Alternatively, the writers are known and how they write is determined. In such embodiments, the known customer attribute 108 may be initially be known and then a number of messages 104 examined to discover semantic attributes 106 which occur for such a set of known customer attributes 108. For example, a particular word or typing mistake may be more common among a number of customers 102. It may be previously determined that those particular customers 102 are highly educated or capable of having conversations at a different educational level than other customers 102. Messages 104 may reveal semantic attributes 106 common to such customers 102.

Attribute analysis engine 110 may have certain threshold requirements to ensure the association of a semantic attribute 106 to a known customer attribute 108 is not made when such an association is no stronger than, for example, a random guess or a normal distribution. Alternatively, attribute analysis engine 110 may still create records in attribute database 112 for associations, such as without regard to whether or not such a semantic attribute occurs as often in the set of users excluded from customers 102, but with an associated degree of matching. For example, the word, “the” may be associated with known customer attribute 108 of “female” with a match of fifty percent. In a further embodiment, a new message received by the contact center which includes the word, “the” may be identified as being associated with a “female” customer attribute 108 with a correlation of fifty percent and a “male” customer attribute 108 with a correlation of fifty percent. The resulting routing decision would be equally weighted with regard to the derived gender of the customer 102. As can be appreciated, other statistical processing methodologies are known in the art and may be employed to prevent and/or negate the effects of semantic attributes 106 which are determined to be poorly correlated to a specific known customer attribute 108.

In still another embodiment, attributes database 112 may be updated based upon later discovered information. For example, a particular word, for example a word that is an idiomatic blend of two or more languages (e.g, Spanglish, Chinglish, etc.) may be discovered and identified as a semantic attribute 106. Associated known customer attributes 108 may be unavailable or otherwise determined to be unusable. However, a later encounter with the particular customer or customers may result in the discovery that known customer attribute 108 is “bi-lingual Spanish/English,” “Non-Native English Speaker,” “Non-Native Spanish Speaker,” or similar designation. A degree of match may also be determined. Once discovered, the previous records within attributes database 112 may then be updated such that future messages 104 which include the particular word may be determined to be associated with the particular known customer attribute 108.

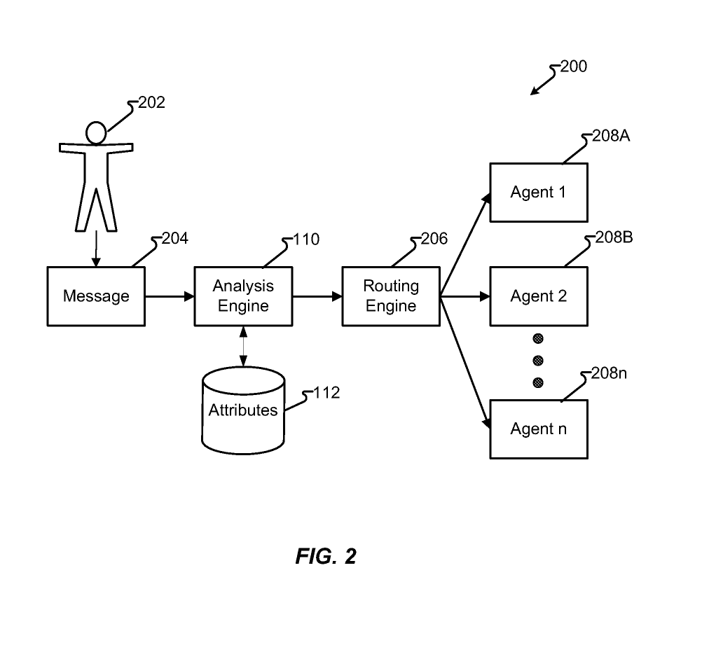

With reference now to FIG. 2, a contact routing diagram 200 will be described in accordance with embodiments of the present disclosure. In one embodiment, unidentified customer 202 sends message 204 which is received by a contact center implementing embodiments herein. It should be noted that message 204 may comprise a single message 104 or multiple messages 104a-n without departing from the scope of the present disclosure. Upon receiving the message 204, analysis engine 110 determines which semantic attributes 106 are present in message 204 and indicative of a customer conversational attribute for which a routing decision may be based. Routing engine 206 then routes the message to one of agents 206 in accord with the determined customer conversational attribute as well as other attributes that have been determined for the customer 202.

In another embodiment, attributes database 112 is populated with additional information from message 204 provided by analysis engine 110. For instance, a particular semantic element may be used to reinforce or weaken a confidence or degree of match. As a further example, if message 204 includes contradictions, such as two words, one associated with male customers and the other associated with female customers, one or both words may have their confidence weakened as to the accuracy of their ability to determine the gender of a customer. On the other hand, if the gender of the customer is later determined, then the word previously indicating the correct gender may have its association with that gender reinforced and/or the word previously indicating the incorrect gender may have its association with that gender weakened.

In another embodiment, attribute database 112 may provide information to the analysis engine 110 that enables the analysis engine 110 to determine a fit to a particular customer category. As one example, the customer category may be expertise in particular subject domain, such as email. Attribute database 112 may include terms associated with a high degree of correlation with the customer attribute of, “email protocol expertise.” One term may be “RFC 3501” and indicate a 90% correlation, whereas another term “email” may indicate a 5% correlation with “email protocol expertise.” One message, such as message 204, which includes both terms may be routed according to various implementations, such as by taking the highest correlation or average correlation. Similarly, feedback may be provided such that the presence of one message element, may bolster the correlation of another message element.

Routing engine 206 may make routing decisions based on a number of attributes, including availability of agents 208 to process a message. In one embodiment, routing engine 206 utilizes the customer category to route the message to the best qualified agent 208. As one example, if customer 202 provided message 204 which indicated a certain customer category (e.g., age, gender, expertise, nationality, language fluency, formality, etc.), a specific agent 208A-208n may be selected based on familiarity and/or similarity with such a customer category. In another embodiment, routing engine 206 utilizes the customer category to route the message to agent 208 identified as most the most effective and/or efficient. As another example, if person 202 provided a message 204 which indicated a low skill level, the specific agent 208A-208n may be selected who has a high level of skill, such as to more quickly diagnose and/or resolve an issue.

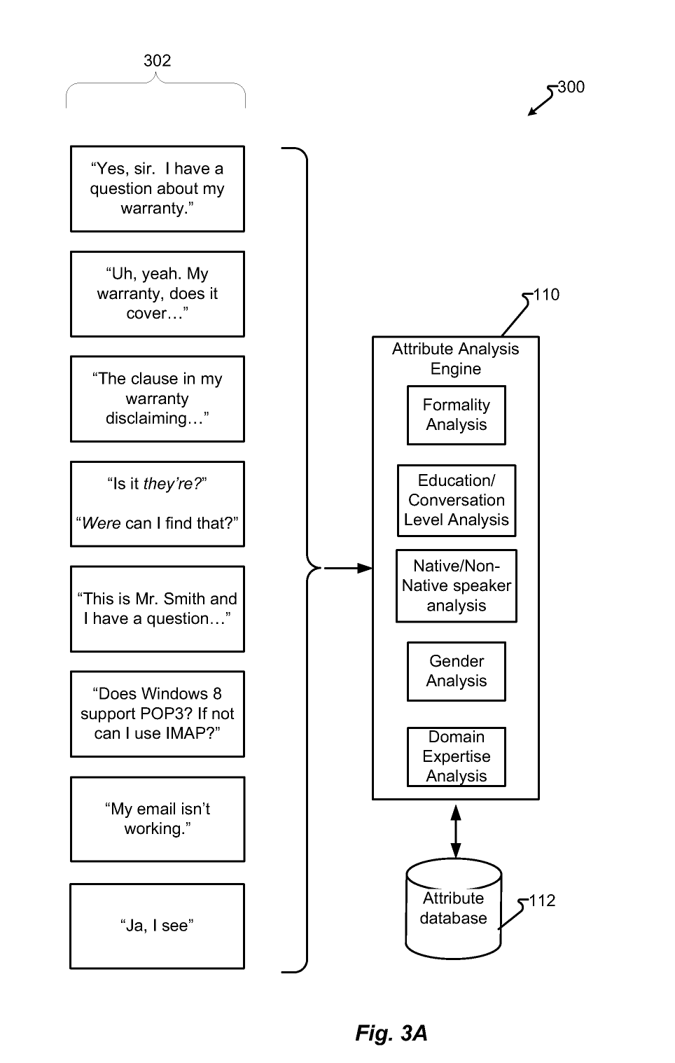

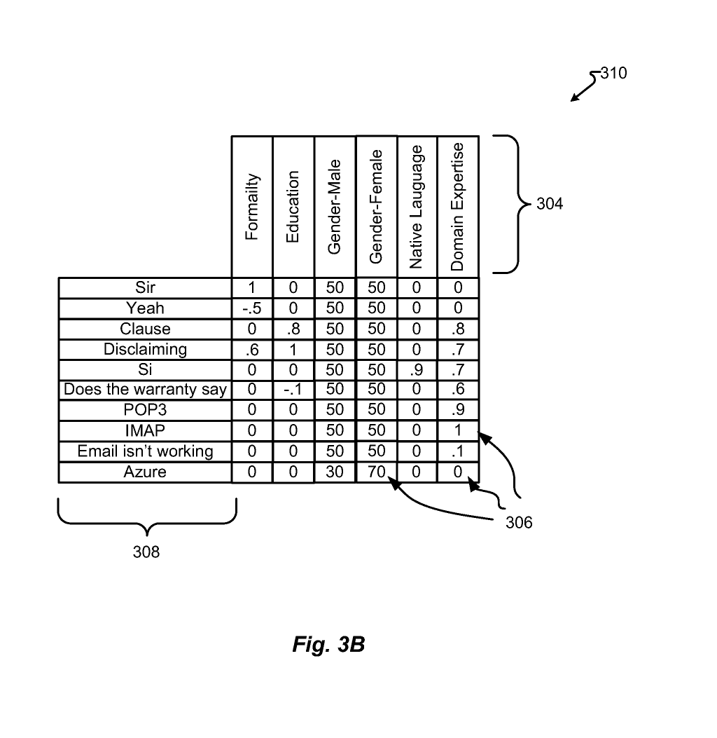

With reference now to FIGS. 3A-3B, a message processing diagram 300 will be described in accordance with embodiments of the present disclosure FIG. 3 illustrates message processing diagram 300 in accordance with embodiments of the present disclosure. In one embodiment, one or more messages are received with a number of message components and compared to a number of semantic attributes 302. A match may be an exact match or a near match, such as a phonetic match or a common misspelling match. The number of semantic attributes 308 are processed by attribute analysis engine 110 to derive or in other embodiments, discover, customer attributes 304. The specific scoring elements 306 of the number of semantic attributes 302 may be a matter of design choice, such as to identify issues or opportunities wherein knowledge of a customer attribute 304 may be useful.

Diagram 300 illustrates various scoring environments whereby the weight of the fit to a particular customer attribute 304 may be provided. In one embodiment, “gender-male” is weighted with a separate “gender-female” whereby the sum of both generally equals one hundred. Due to rounding or other factors sums may not equal one hundred. In other embodiments, one of customer attributes 304 may be “gender-male” whereby a low score is interpreted to indicate a weighting towards, “not gender-male” or “gender-female.” Neutral scores may be zero, scores indicating a better match may then be positive whereas poorer matches are negative. It should be appreciated that other scoring means may be implemented without departing from the teachings herein.

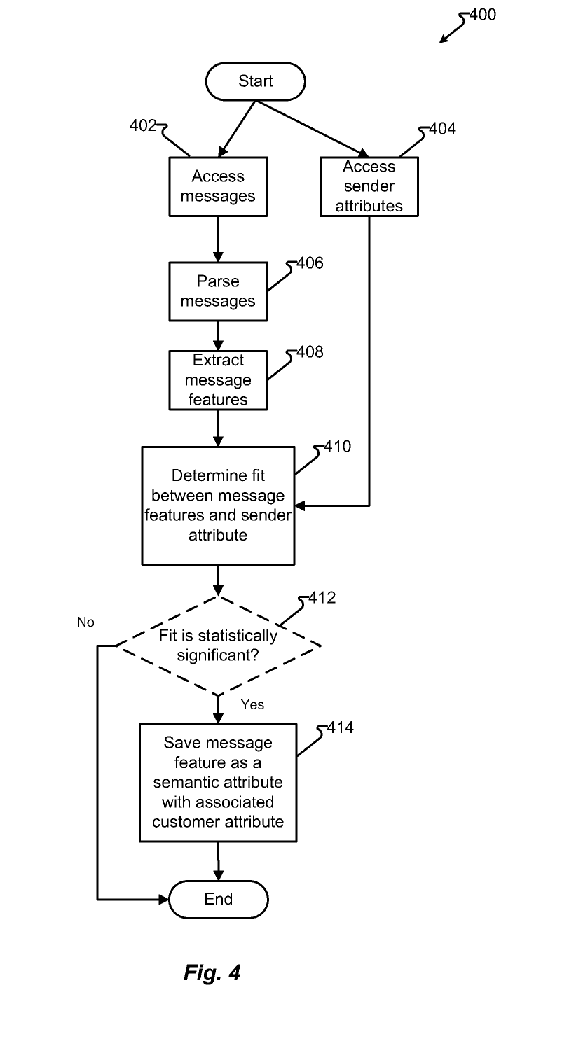

With reference to FIG. 4 illustrates flowchart 400 will be described in accordance with embodiments of the present disclosure. In one embodiment, a record is created in attribute database 112. Flowchart 400 starts with step 402 accessing a message and accessing customer attributes 404. Accessing messages 402 and accessing customer attribute 404 may be performed synchronously, such as when a message is received or accessed with a known customer, or may be performed asynchronously, such as when customer attributes are unknown at the time a message is accessed or received.

Step 406 parses the message into components such as words, phrases, non-word elements (e.g., punctuations, metadata, etc.). Step 408 extracts message features. In one embodiment, the message features are ones of the message components extracted in step 406. In another embodiment, message features are filtered to remove certain “noise” elements which have been identified as non-indicative of any particular customer attribute, such as common words, phrases, and so on. Step 410 determines the fit between one or more customer attributes and message features.

As an option step 412 determines if a particular message attribute is a statistically significant fit to a particular customer attribute matched in step 410. If a particular fit is determined to be below a certain threshold, such as to be unusable to derive a customer attribute with any useful degree of certainty, then flowchart 400 may terminate. In a further embodiment, step 412 determines if a fit is statistically significant upon determining the fit is better than a random or normal distribution of all messages received.

Step 414 saves the message feature and the associated customer attribute for future access. In a further embodiment, the fit is also saved such that a future message with the same message feature can be matched to the customer category with an associated degree of certainty. Flowchart 400 may then terminate or resume with step 402 accessing additional messages and/or step 404 accessing additional customer attributes.

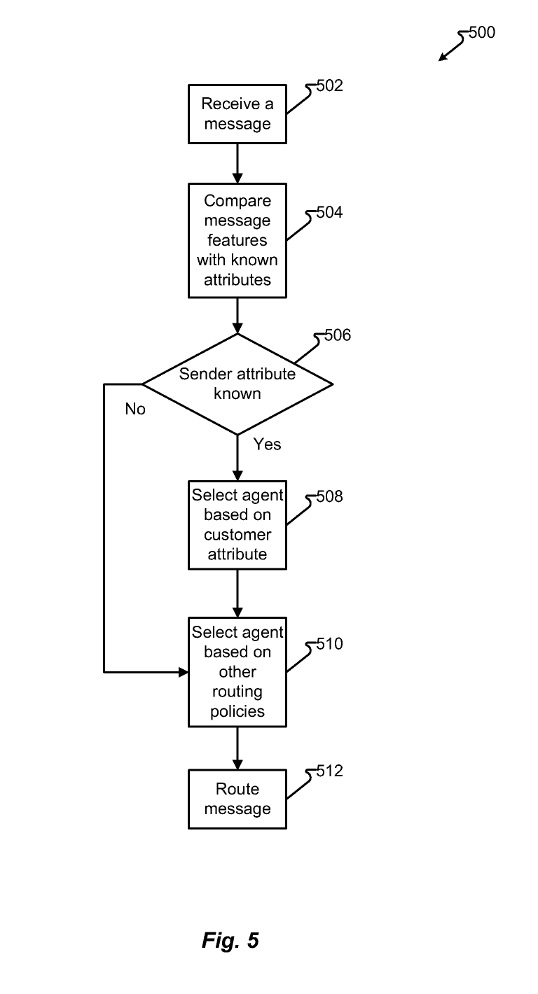

With reference to FIG. 5, flowchart 500 will be described in accordance with embodiments of the present disclosure. In one embodiment, a received message is processed. Flowchart 500 starts when step 502 receives a message. Step 504 compares various message features with known attributes, such as by accessing records of attribute database 112. Step 506 determines if a customer attribute is known or, optionally, known with a degree of certainty above a threshold. If yes, step 508 selects an agent based on the customer attribute. If step 506 is no, processing may continue to step 510 or other appropriate routing decision step. Step 508 may directly precede step 512 whereby the message is routed by step 512 based on the customer attribute and an agent selected according to the customer attribute. In other embodiments, step 510 further refines the agent selected process such as to select a particular agent based on availability, load balancing, skills unrelated to the customer attribute, or other aspect as may be determined by a contact center implementing flowchart 500. Step 512 then routes the message to the agent for processing.

Optionally, the agent may be presented with questions to further derive customer attributes. In one embodiment, step 502 is processed by a first agent, whether human or automated, such as for the purpose of gathering preliminary information. During and/or after such an interaction the first agent may be prompted with questions to determine one or more customer attributes. Questions may be specific as for a customer attribute, such as, “Do you believe the customer of the message is male, female, educated, etc.” Questions may be experience related, such as, “Did the customer use words like ‘sir?’” or “Did the customer use the word ‘(formal) you’?” (such as in German, French, or other languages where words, such as “you” have a formal and an informal form).

In some embodiments, the message received in step 502 is from a known customer with a known customer attribute. Such may be the case when the same customer has had a previous interaction with the contact center which resulted in an prior iteration of flowchart 500. Since the customer attribute is known, step 508 may be executed after step 502. In yet another attribute, the message 502 may be further processed to determine the accuracy of derived customer attribute. If such a determination is accurate, the degree of match between the message element and the customer attribute may be increased or decreased as appropriate. For example, if the use of a particular word is determined to indicate a customer attribute of “female,” but an interaction concludes that the customer was male, the confidence, correlation, or other matching factor may be decreased to reflect the inaccuracy of the prior determination.

While routing a message to an appropriate agent is one embodiment herein, other benefits may also be utilized. In another embodiment, an agent responding to a message may have their response monitored and, if the response is not in agreement with the derived customer attribute, the agent may be informed so that corrections may be made. For example, if the customer attribute is determined to indicate a low level of domain expertise, but the agent is writing a reply that is typically understood only by experts in the domain, the agent may be informed of the discrepancy. The agent may then reformulate his or her response to better accommodate the customer's background.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A method, comprising:
receiving a message from a customer, the message having message elements;
deriving a customer attribute based on a semantic analysis of the message elements;
selecting an agent from a plurality of agents in a contact center to interact with the customer based, at least in part, on the derived customer attribute; and
enabling a communication session between the selected agent and customer.

2. The method of claim 1, wherein the derived customer attribute is a degree of estimated matching to the derived customer attribute.

3. The method of claim 1, wherein the derived customer attribute comprises a formality-informality conversational preference.

4. The method of claim 1, wherein the derived customer attribute comprises an estimated educational level of the customer.

5. The method of claim 1, wherein the derived customer attribute comprises as estimated gender.

6. The method of claim 1, wherein the derived customer attribute comprises a native language.

7. The method of claim 1, wherein the derived customer attribute comprises a technical expertise level.

8. The method of claim 1, further comprising:
monitoring the agent's reply to the message;
analyzing the agent's reply; and
upon determining the analyzed agent's reply is not in accord with the derived customer attribute, notifying the agent that the agent's reply is not in accord with the derived customer attribute.

9. A non-transitory computer readable medium with instructions, that when executed by a computer, cause the computer to perform:
receiving a number of messages from customers having a customer attribute;
determining a correlation between a semantic attribute in the number of messages and the customer attribute; and
storing the semantic attribute and correlated customer attribute in a database.

10. The instructions of claim 9, wherein, at least one of the number of messages is a transcript of a voice message.

11. The instructions of claim 9, wherein storing the semantic attribute and correlated customer attribute, further comprises, storing an associated degree of correlation.

12. The instructions of claim 9, further comprising:
identifying a known customer attribute from a subsequent message having the semantic attribute; and
updating the stored semantic attribute and correlated customer attribute in accord with the known customer attribute.

13. A system, comprising:
a processor; and
a communication interface; and
wherein the communication interface is operable to receive a message from a customer;
wherein the processor is operable to determine whether the message has a message semantic attribute;
wherein the processor is further operable to derive a message customer attribute from the message semantic attribute; and
wherein the processor is further operable to make a routing decision for a communication exchange between the customer and an agent based in part on the derived message customer attribute.

14. The system of claim 13, further comprising:
a network interface; and
wherein the processor is further operable cause the message to be sent to the agent via the network interface.

15. The system of claim 14, further comprising:
the processor sending a query to the agent prompting a response to the agent's assessment of the accuracy of the association of the message customer attribute and derive the message customer attribute from the message semantic attribute in accord with the accuracy.

16. The system of claim 13, further comprising:
a database having a record including a stored semantic attribute and a stored customer attribute; and
the processor derives the derived customer attribute upon determining the message semantic attribute matches the stored semantic attribute.

17. The system of claim 16, wherein:
the processor accesses a discovered association between the derived customer attribute and the message semantic attribute and updates the stored semantic attribute in accord with the discovered association.

18. The system of claim 16 wherein the processor is operable to determine whether the message has the message semantic attribute upon parsing a number of portions of the message and comparing ones of the number of portions to the stored semantic attribute.

19. The system of claim 13, wherein the derived message customer attribute is at least one of formality, education, gender, domain expertise, first language fluency, and second language fluency different from the first language.

20. The system of claim 13, wherein the processor derives a message customer attribute from the message semantic attribute further comprising a correlation factor between the same.
